(19) United States
(12) Patent Application Publication
(10) Pub. No.: US 2015/0316209 A1
(43) Pub. Date: Nov. 5, 2015

(54) Pressure Vessel With High Tension Winding to Reduce Fatigue

(71) Applicant: BLUE WAVE CO S.A., Luxembourg (LU)

(72) Inventors: Francesco NETTIS, London (GB); Brian SPENCER, Sacramento, CA (US); Zachary SPENCER, Sacramento, CA (US); Vanni Neri TOMASELLI, Luxembourg (LU)

(21) Appl. No.: 14/649,463

(22) PCT Filed: Dec. 5, 2012
(86) PCT No.: PCT/EP2012/074579

§ 371 Date: Jun. 3, 2015

(51) Int. Cl. F17C 1/06; F17C 1/14

(52) U.S. Cl. CPC F17C 1/06; F17C 1/14; F17C 2201/0104; F17C 2203/0663; F17C 2209/2154

(57) ABSTRACT

This invention relates to a pressure vessel that is wrapped with a high-tension winding that prevents or ameliorates the effects of fatigue due to cyclic pressurizing and de-pressurizing of the vessel.

### FIELD

This invention relates to materials science, in particular to the reduction of the effects of fatigue in pressure vessels due to cyclic loading and unloading of compressed fluids.

### BACKGROUND

The detrimental effects of the burning of fossil fuels on the environment are becoming more and more of a concern and have spurred great interest in alternative energy sources. While progress is being made with solar, wind, nuclear, geothermal, and other energy sources, it is quite clear that the widespread availability of economical alternate energy sources, in particular for high energy use applications, remains an elusive target. In the meantime, fossil fuels are forecast to dominate the energy market for the foreseeable future. Among the fossil fuels, natural gas is the cleanest burning and therefore the clear choice for energy production. There is, therefore, a movement afoot to supplement or supplant, as much as possible, other fossil fuels such as coal and petroleum with natural gas as the world becomes more conscious of the environmental repercussions of burning fossil fuels. Unfortunately, much of world's natural gas deposits exist in remote, difficult to access regions of the planet. Terrain and geopolitical factors render it extremely difficult to reliably and economically extract the natural gas from these regions. The use of pipelines and overland transport has been evaluated, in some instances attempted, and found to be uneconomical. Interestingly, a large portion of the earth's remote natural gas reserves is located in relatively close proximity to the oceans and other bodies of water having ready access to the oceans. Thus, marine transport of natural gas from the remote locations would appear to be an obvious solution. The problem with marine transport of natural gas lies largely in the economics and one of the economic concerns is the useful lifespan of the pressure vessels in which the natural gas is to be transported. Among the factor affecting the useful lifespan of a pressure vessel is fatigue, the progressive structural damage to the material of which the pressure vessel is fabricated caused by the cyclic pressurization on loading and de-pressurizing on unloading of the pressure vessels. Such structural damage substantially reduces the useful lifespan of the pressure vessel can, if unchecked, result in catastrophic failure of the vessel.

An established approach to mitigating the effects of fatigue on metals subjected to cyclic high pressure loading and unloading is autofrettage. Autofrettage involves the application of extreme pressure to the interior surface of a cylindrical vessel resulting in the plastic deform of the inner surface of the metal of which the cylindrical vessel is fabricated. The pressure is calculated to exceed the yield strength of the metal so that the metal does not return to its original dimension when the pressure is removed. This results in residual tangential compressive stresses on the metal which can counteract the effects of cyclic high pressure loading of the vessel when in use and thereby significantly extend the useful lifespan of the vessel.

Autofrettage is accomplished basically in two ways. The first, applicable primarily to relatively small bore vessels, is the insertion of a mandrel into the bore where the mandrel has a slightly larger diameter than the bore. The radial pressure exerted by the mandrel as it is forced into the bore compresses the metal inside the bore beyond its yield strength resulting in autofrettage.

An alternative means of accomplishing autofrettage is by the application of a pressure sufficient to deform the inside diameter of a cylinder using a fluid which is injected into the cylinder and then pressurized. While this technique is theoretically suitable for vessels of virtually any diameter, it requires the generation of extremely high pressures, often reaching or exceeding 200,000 psi, depending on the physical properties of the metal of which the cylinder is fabricated. To achieve these pressures requires large, complex and expensive equipment and, of course, raises serious safety concerns, especially with very large diameter vessels such as those contemplated for use in the containment and transport of compressed natural gas.

It would nevertheless be extremely useful to the natural gas transport industry if the beneficial effects of autofrettage could be achieved in pressure vessels such as those contemplated herein without undergoing the currently required autofrettage process. The present invention provides a pressure vessel that exhibits the beneficial effects of autofrettage without undergoing the process and method of accomplishing same.

### SUMMARY

Thus, in one aspect, this invention relates to a pressure vessel comprising a metal cylindrical section having an inside diameter and a thickness wherein the thickness is from 1/100 to 1/1000 of the inside diameter; and a filamentous material that is hoop-wound, isotensoidally-wound, or both hoop-wound and isotensoidally-wound around substantially the entire cylindrical section at a tension of about 70% to about 99% of the compressive yield strength of the metal of which the cylindrical section is fabricated.

In an aspect of this invention, the filamentous material is at a tension of about 95% to about 99% of the compressive yield strength of the metal of which the cylindrical section is fabricated.

In an aspect of this invention, the metal is a base metal or a metal alloy.

In an aspect of this invention, the base metal is selected from the group consisting of iron, steel, stainless steel and aluminum

In an aspect of this invention, the alloy is selected from the group consisting of an aluminum alloy and a nickel-based alloy.

In an aspect of this invention, the filamentous material comprises a natural filament, a synthetic filament or a semi-synthetic filament.

In an aspect of this invention, the natural filament is selected from the group consisting of silk, cotton, wool, flax, hemp, jute, kenaf, ramie and combinations thereof.

In an aspect of this invention, the synthetic filament is selected from the group consisting of metal fibers, ceramic fibers, glass fibers, carbon fibers, aramid fibers, polyolefin fibers, polyacrylate fibers, polyamide fibers, polyesters fibers, and combinations thereof.

In an aspect of this invention, the synthetic filament is selected from the group consisting of fiberglass, carbon fiber, ultra high molecular weight polyethylene and aramid (Kevlar).

In an aspect of this invention, the cylindrical section comprises at least a portion of a pressurized pipeline.

In an aspect of this invention, the pressure vessel further comprises one or two domed end section(s) coupled to one or both ends of the cylindrical section.

In an aspect of this invention, the domed end section(s) are comprised of a metal, which may be the same as or different from the metal of which the cylindrical section is fabricated, or of a polymeric composite.

In an aspect of this invention, the pressure vessel is for the containment and transport of compressed natural gas.

An aspect of this invention is a method of preventing or reducing fatigue in a pressure vessel having a metal cylindrical section, comprising: hoop-, isotensoidally-, or hoop- and isotensoidally-wrapping substantially the entire cylindrical section with a filamentous material at a tension of about 70% to about 99% of the compressive yield strength of the metal of which the cylindrical section is fabricated, wherein radial force within in the cylindrical section exerted by a pressurized fluid contained in the pressure vessel is substantially absorbed by the filamentous material and not the metal of the cylindrical section.

In an aspect of this invention, in the above method, the pressure vessel further comprises one or two domed end sections coupled to proximal and distal ends of the cylindrical section.

In an aspect of this invention, in the above method, the pressure vessel is for the containment and transport of compressed natural gas.

In an aspect of this invention, in the above method, the cylindrical section comprises at least a portion of a pressurized pipeline.

### BRIEF DESCRIPTION OF THE FIGURES

These figures are provided for illustrative purposes only and are not intended nor should they be construed as limiting this invention in any manner whatsoever.

FIG. 1 is a schematic representation of a pressure vessel with a cylindrical center section and two domed end sections.

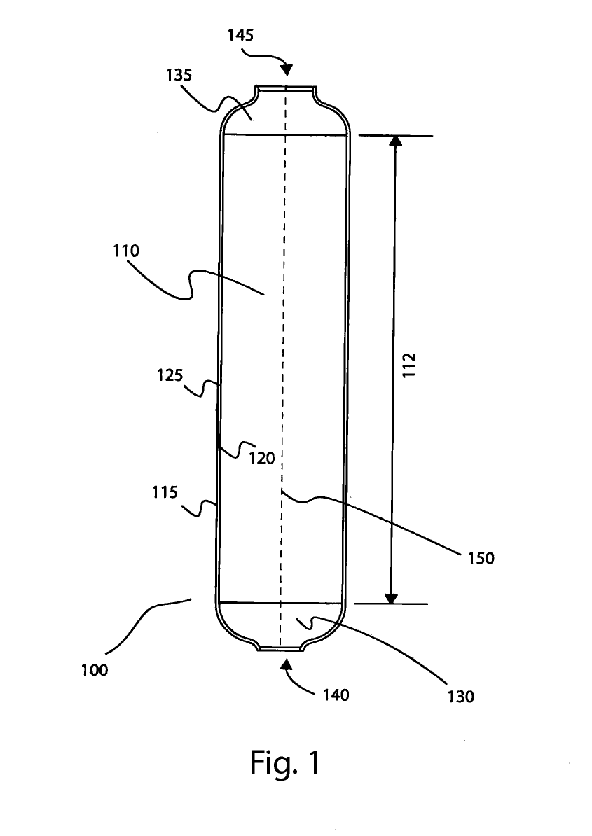

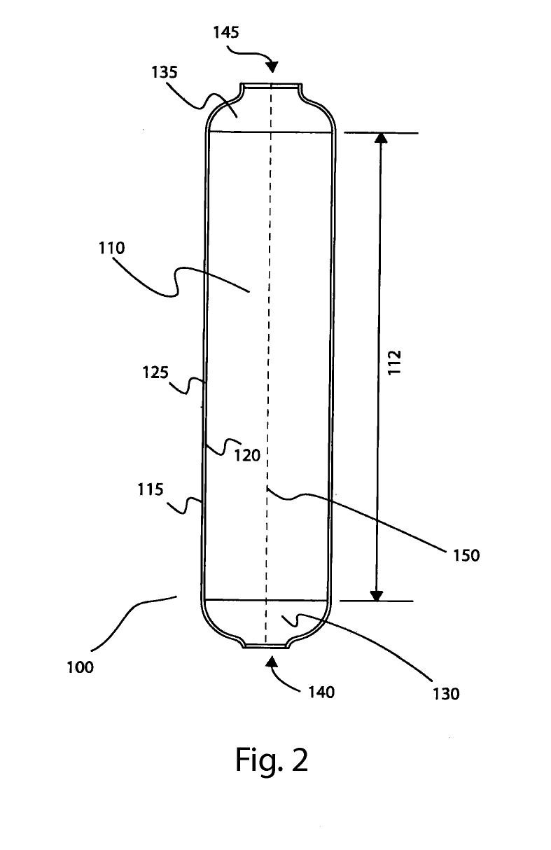

### DETAILED DESCRIPTION

Discussion

What follows is a description of the general procedures and processes for winding or wrapping a pressure vessel in order to render the vessel capable of withstanding the pressure exerted by a contained fluid under pressure. When, however, the pressure vessel is fabricated of a metal which is subsequently wound with a filamentous material to reinforce the vessel or when the vessel comprises a metal liner that requires a composite wrap to instill virtually all of its strength, under current wrapping parameters the metal portions of the vessel are still subject to fatigue and possible early failure. That is, the filaments are generally wound around the vessel from multiple spools of the filament and each spool is under a tension of about 3 to 5 pounds. This is insufficient to achieve an autofrettage-like residual stress in the metal and therefore as the metal is subjected to a fluid under pressure and thereby compressed and then release of that pressure and subsequently de-compressing, the metal will fatigue. The method of this invention solves this problem by increasing the tension of each spool of filament by about 5- to about 25-fold, preferably at present, by about 5- to about 20-fold that of the customary spool tension in the industry. While these pressures are not generally sufficient to induce an autofrettage-like permanent deformation in the surface layer of the subject metal, they will be sufficient to put the metal, in particular the metal abutting the winding, in a state of permanent compressive stress to mimic the effect of autofrettage. The actual tension of the winding spools is determined by the compressive yield strength of the particular metal or alloy.

Compressive yield strength is defined as the lowest stress that produces a permanent deformation in a material. The yield strength of most metal and many alloys are well-known and can be obtained from various readily available sources. If such public sources do not reveal the desired yield strength, such can be empirically determined by techniques well-known in the art and which do not require further explication herein. With the instant invention in hand, the following is presented to aid in the general understanding of wrapped or wound pressure vessels.

For the purposes of this invention, once the yield strength of the metal is determined, the metal is wound with the filamentous material at a tension that is about 70% to about 99%, preferably about 95% to about 99%, of the compressive yield strength of the metal.

In order to be effective, the stress on the metal must be sufficient to affect a give a desired stress profile to a reasonable depth in the metal. To accomplish this, it is an embodiment of this invention that the thickness of the metal be about 1/100 to 1/1000 of the inside diameter of the vessel.

With the above in mind, it is understood that, with regard to this description and the appended claims, reference to any aspect of this invention made in the singular includes the plural and vice versa unless it is expressly stated or unambiguously clear from the context that such is not intended.

Further, as used herein, any term of approximation such as, without limitation, near, about, approximately, substantially, essentially and the like, mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the word or phrase unmodified by the term of approximation. In general, but with the preceding discussion in mind, a numerical value herein that is modified by a word of approximation may vary from the stated value by ±10%, unless expressly stated otherwise. Thus for instance, without limitation, when it is stated that a filamentous material substantially completely absorbs the pressure exerted on the metal of a pressure vessel, it is understood that the filamentous material could in fact absorb 90% to 100% of the exerted pressure.

Likewise, the use herein of “preferred,” “preferably,” or “more preferred,” and the like refers to preferences as they existed at the time of filing of this patent application.

As used herein, a “polymeric composite” has the meaning that would be ascribed to it by those skilled in the art. In brief, it refers to a fibrous or filamentous material that is impregnated with, enveloped by or both impregnated with and enveloped by a polymer matrix material.

As used herein a “a pressure vessel” refers in the first instance to a container as such are generally known and used for holding and transporting fluids, generally gasses, under pressure. For example, without limitation, oxygen, nitrogen and acetylene are fluids that are commonly stored and sold in pressure vessels. For the purpose of this invention, however, a pressure vessel also refers to a pipeline through which fluids under pressure are transported from one location to another.

Container-type pressure vessels for the transport of compressed fluids, such as compressed natural gas, CNG, presently constitute four regulatory agency approved classes, all of which are cylindrical with one or two domed ends:

Class I. Comprises an all metal, usually aluminum or steel, construct. This type of vessel is inexpensive but is very heavy in relation to the other classes of vessels. Although Type I pressure vessels currently comprise a large portion of the containers used to ship compressed fluids by sea, their use in marine transport incurs very tight economic constraints.

Class II. Comprises a thinner metal cylindrical center section with standard thickness metal end domes in which only the cylindrical portion is reinforced with a composite wrap. The composite wrap generally constitutes glass or carbon filament impregnated with a polymer matrix. The composite is usually “hoop wrapped” around the middle of the vessel. The domes at one or both ends of the vessel are not composite wrapped. In Class II pressure vessels, the metal liner carries about 50% of the stress and the composite carries about 50% of the stress resulting from the internal pressure of the contained compressed fluid. Class II vessels are lighter than Class I vessels but are more expensive.

Class III. Comprises a thin metal liner for the entire structure wherein the liner is reinforced with a filamentous composite wrap around entire vessel. The stress in Type III vessels is shifted virtually entirely to the filamentous material of the composite wrap; the liner need only withstand a small portion of the stress. Type III vessels are much lighter than type I or II vessels but are substantially more expensive.

Class IV. Comprises a polymeric essentially gas-tight liner that is fully wrapped with a filamentous composite. The composite wrap provides the entire strength of the vessel. Type IV vessels are by far the lightest of the four approved classes of pressure vessels but are also the most expensive.

With regard to the method of this invention, Class II and Class III pressure vessels are of primary interest, Class II being all metal by definition and Class III requiring a metal liner. Type I vessels could, of course, also be wound with a filamentous material as set forth herein but such a wrapped vessel would essentially be a Class II vessel.

As noted above, Type II and Type III pressure vessels require a composite wrap to give them the necessary strength to withstand the pressure exerted by a compressed fluid contained in the vessel. For a Type II pressure vessel, the wrap is relatively straight-forward and is referred by those skilled in the art as “hoop-wrapping,” or hoop-winding” which is described elsewhere herein and which is very well-known to those skilled in that art. The resulting vessel is referred to as being “hoop-wound.” On the other hand, for Type III vessels, to produce a vessel that has the requisite strength it is necessary to wrap the vessel, sometimes in addition to hoop-wrapping, sometimes in lieu of hoop-wrapping, in a manner referred to as “isostensoidal-wrapping,” which is likewise known in the art and is also described elsewhere herein.

With regard to a Type III vessel, the underlying metal construct is conventionally referred to as a “liner” and it provides the surface on which the composite wrap is wound and is the surface with which the contained compressed fluid is in direct contact.

As used herein, a “fluid” refers to a gas, a liquid or a mixture of gas and liquid. For example, without limitation, a fluid refers to natural gas. When natural gas is placed in a pressure vessel for transport, it is referred to as “compressed natural gas” or simply “CNG.” CNG may be contained and transported in the vessels of this invention both as a purified gas and as “raw gas.” Raw gas refers to natural gas as it comes, unprocessed, directly from the well. It contains, of course, the natural gas (methane) itself but also may contain liquids such as condensate, natural gasoline and liquefied petroleum gas. Water may also be present as may other gases, either in the gaseous state or dissolved in the water, such as nitrogen, carbon dioxide, hydrogen sulfide and helium. Some of these may be reactive in their own right or may be reactive when dissolved in water, such as carbon dioxide and hydrogen sulfide which produces an acid when dissolved in water.

As used herein, a “base metal” refers to a metal selected from the group consisting of iron, nickel, copper, lead, zinc, aluminum, tin, molybdenum, tantalum, titanium, zirconium and chromium. Presently preferred are iron and aluminum.

As used herein, an “alloy” has the meaning normally ascribed to the term by those skilled in the art. Any alloy found suitable for fabricating pressure vessels is within the scope of this invention including but not limited to alloys of iron, copper, nickel, and aluminum. Presently preferred alloys are various steels, in particular stainless steel.

As used herein, a pressure vessel “wrap” or “winding” refers to the a filamentous material that is wound around a substantially cylindrical portion of the pressure vessel. The filamentous material may be wound around the vessel in a dry state and left as such or it may subsequently be impregnated with and embedded in polymeric matrix.

Alternatively, the filamentous material may be impregnated with a polymeric matrix prior to being wound onto a construct in which case it also becomes embedded in excess matrix material.

While it is hardly a trivial exercise, it is a well-established procedure to design and apply to a pressure vessel liner a filamentous material to achieve a fully wound vessel of optimum strength. In brief, for a given diameter cylindrical section of a pressure vessel liner, a given polar opening (through which the vessel is filled an emptied) diameter, a given dome shape and a given filament width, a winding pattern can readily be determined using known algorithms including, without limitation, netting analysis, finite element analysis and combinations thereof. Using these mathematical formulae permits the design of a winding pattern that results in an isotensoidal wrap of the vessel.

The term “isotensoidal” refers to the property of the fully wound vessel in which each filament of the wrap experiences a constant pressure at all points in its path. This is currently considered to be the optimal design for wrapping a Type III pressure vessel because, in this configuration, virtually the entire stress imposed on the vessel by a compressed fluid is assumed by the filaments of the composite with very little of the stress being assumed by metal of the liner. Such pressure vessels exhibit the optimal combination of high pressure loading at the lightest overall weight.

Again, it is emphasized that, while the above isotensiodal composite wrap absorbs the gross pressure of the fluid in the Class III vessel, the metal of the liner still is compressed and decompressed with each loading and unloading of the vessel and therefore will still be subject to fatigue and eventual failure. It is the fatigue and failure of the liner that this invention is intended to mitigate.

A schematic of a pressure vessel liner that can be subjected to the method of this invention is shown in FIG. 2. As mentioned previously, the composite overwrap, while constituting relatively sophisticated design mathematics and implementation machinery, is well-known to those skilled in the pressure vessel design and fabrication art.

Pressure vessel liner 100 shown in FIG. 2 is comprised of cylindrical center section 110 having length 112, outer surface 115, inner surface 120, thickness 125, domes 130 and 135 and polar openings 140 and 145.

It is possible and is within the scope of this invention that a pressure vessel of this invention may comprise a polar opening in only one of domes 130 and 135.

The domes as shown are rounded to blend from the cylinder, through the shoulders and up to the neck. They can also assume other curved shapes, including generally hemi-spherical shapes.

The dome of a pressure vessel liner may have a fairly broad range of contours. Most often, however, the contours comprise a 2:1 ellipsoidal, a 3:1 ellipsoidal or a geodesic shape. Most common and presently preferred is a geodesic contour. A geodesic contour is readily amendable to analysis using the previously mentioned netting and finite element analysis to determine the optimal filamentous winding pattern to create an isotensoidal wrap on all portions of the pressure vessel including domes containing polar openings.

It is noted that, in this disclosure, no actual thicknesses or amounts of composite wrapping are expressly set forth. This is so because the thicknesses of the various sections of a pressure vessel and the amount of wrapping are predominantly dependent on the operating pressure of the vessel. The pressures are, of course, predetermined and exceeding them could result in catastrophic failure of the pressure vessel.

Once the maximum operating pressure of a vessel is established and a metal is selected for the fabrication of the vessel or vessel and the physical properties of the metal are thus defined, it is a straight-forward application of engineering principles to determine the requisite thicknesses and amounts of wraps to achieve the correct bulk strength of vessel. Thus, since maximum operating pressures can vary substantially, it is unnecessary to expressly set forth any such specific dimensions for the purposes of this invention.

In general, any type of filamentous material may be used to create the polymeric composites of this invention. That is, the filament may be natural, semi-synthetic or completely synthetic. Non-limiting examples of natural filaments include silk, cotton, wool, flax hemp, jute, kenaf and ramie. Examples, likewise without limitation, of synthetic filaments include metal, ceramic, glass, carbon, aramid, polyolefin, polyacrylate, polyamide and polyester filaments.

Presently preferred materials include glass fibers, commonly known as fiberglass, carbon fibers, aramid fibers, which go mostly notably under the trade name Kevlar® and ultra-high molecular weight polyethylene, such as Spectra° (Honeywell Corporation) and Dyneeva® (Royal DSM N.V.).

The pressure vessel liner of a Class III vessel may comprise a metal such as, without limitation, stainless, steel, zinc, copper, tin, aluminum and combinations and alloys thereof.

A Class II pressure vessel may be, without limitation, fabricated of iron, any one of a number of types of steel with stainless steel being presently preferred, aluminum or an aluminum alloy or a nickel alloy.

What is claimed:

1. A pressure vessel comprising:
a metal cylindrical section having an inside diameter and a thickness wherein the thickness is from 1/100 to 1/1000 of the inside diameter; and
a filamentous material that is hoop-wound, isotensoidally-wound, or both hoop-wound and isotensoidally-wound around substantially the entire cylindrical section at a tension of about 70% to about 99% of the compressive yield strength of the metal of which the cylindrical section is fabricated.

2. The pressure vessel of claim 1, wherein the filamentous material is at a tension of about 95% to about 99% of the compressive yield strength of the metal of which the cylindrical section is fabricated.

3. The pressure vessel of claim 1, wherein the metal is a base metal or a metal alloy.

4. The pressure vessel of claim 3, wherein the base metal is selected from the group consisting of iron, steel, stainless steel and aluminum

5. The pressure vessel of claim 3, wherein the alloy is selected from the group consisting of an aluminum alloy and a nickel-based alloy.

6. The pressure vessel of claim 1, wherein the filamentous material comprises a natural filament, a synthetic filament or a semi-synthetic filament.

7. The pressure vessel of claim 6, wherein the natural filament is selected from the group consisting of silk, cotton, wool, flax, hemp, jute, kenaf, ramie and combinations thereof.

8. The pressure vessel of claim 6, wherein the synthetic filament is selected from the group consisting of metal fibers, ceramic fibers, glass fibers, carbon fibers, aramid fibers, polyolefin fibers, polyacrylate fibers, polyamide fibers, polyesters fibers, and combinations thereof.

9. The pressure vessel of claim 8, wherein the synthetic filament is selected from the group consisting of fiberglass, carbon fiber, ultra high molecular weight polyethylene and aramid (Kevlar).

10. The pressure vessel of claim 1, wherein the cylindrical section comprises at least a portion of a pressurized pipeline.

11. The pressure vessel of claim 1, further comprising one or two domed end section(s) coupled to one or both ends of the cylindrical section.

12. The pressure vessel of claim 11, wherein the domed end section(s) are comprised of a metal, which may be the same as or different from the metal of which the cylindrical section is fabricated, or of a polymeric composite.

13. The pressure vessel of claim 11 or claim 12, wherein the pressure vessel is for the containment and transport of compressed natural gas.

14. A method of preventing or reducing fatigue in a pressure vessel having a metal cylindrical section, comprising:
hoop-winding, isotensoidally-winding, or hoop-winding and isotensoidally-winding substantially the entire cylindrical section with a filamentous material at a tension of about 70% to about 99% of the compressive yield strength of the metal of which the cylindrical section is fabricated, wherein:
radial force generated within the cylindrical section exerted by a pressurized fluid contained in the pressure vessel is substantially absorbed by the filamentous material and not the metal of the cylindrical section.

15. The method of claim 14, wherein the pressure vessel further comprises one or two domed end sections coupled to proximal and distal ends of the cylindrical section.

16. The method of claim 15, wherein the pressure vessel is for the containment and transport of compressed natural gas.

17. The method of claim 14, wherein the cylindrical section comprises at least a portion of a pressurized pipeline.
